(19) United States
(12) Patent Application Publication
(10) Pub. No.: US 2021/0326107 A1
(43) Pub. Date: Oct. 21, 2021

(54) HARDWARE ACCELERATION MACHINE LEARNING AND IMAGE PROCESSING SYSTEM WITH ADD AND SHIFT OPERATIONS

(71) Applicant: Samsung Electronics Co., Ltd., Suwon-si (KR)

(72) Inventors: Lilong SHI, Pasadena, CA (US); Chunji WANG, Los Angeles, CA (US); Yibing Michelle WANG, Temple City, CA (US); Kwang Oh KIM, Cerritos, CA (US)

(21) Appl. No.: 16/903,335

(22) Filed: Jun. 16, 2020

Related U.S. Application Data
(60) Provisional application No. 63/013,531, filed on Apr. 21, 2020.

(51) Int. Cl. G06F 5/01; G06F 17/17

(52) U.S. Cl. CPC G06F 5/012; G06N 20/00; G06F 17/17

(57) ABSTRACT

A system and a method are disclosed to approximately calculate a mathematical function using a digital processing device. An acceleration function is performed on at least one operand for a mathematical function. The acceleration function includes a predetermined sequence of addition operations that approximate the mathematical function in which the mathematical function may be a base-2 logarithm, a power of 2, a multiplication, an inverse square root, an inverse, a division, a square root, and an arctangent. The predetermined sequence of addition operations may include a first predetermined number of additions of integer-formatted operands and a second predetermined number of additions of floating-point-formatted operands in which the additions of integer-formatted operands and additions of floating-point-formatted operands can occur in any order.

### CROSS-REFERENCE TO RELATED APPLICATION

This application claims the priority benefit under 35 U.S.C. § 119(e) of U.S. Provisional Application No. 63/013,531, filed on Apr. 21, 2020, the disclosure of which is incorporated herein by reference in its entirety.

### TECHNICAL FIELD

The subject matter disclosed herein relates to computing devices. More specifically, the subject matter disclosed herein relates to a system and a method in which complex mathematical functions are replaced by approximations that use add and shift operations.

### BACKGROUND

Machine-learning (ML) training and inference applications typically involve complex mathematical functions that are computationally expensive using 32-bit floating-point operations to perform multiplication for functions, such as a convolution, a dot-product and a matrix multiplication. Other complex mathematical functions that may be used that are computationally expensive, include, but not limited to, a square root, a logarithm, a division, a trigonometric function (sine and/or cosine), and a Fourier transform. Additionally, the hardware that is used for ML training and inference applications may typically have a large power-consumption characteristic and may cover a correspondingly large hardware footprint (area) on a chip.

Creating a small hardware footprint for a diverse set of complex mathematical computations may include significant design trade-off considerations. On the other hand, however, it may beneficial to simplify a set of mathematical operations in order to reduce the area of the hardware footprint on a chip while also reducing power consumption. For example, mobile phones have a limited available power. Therefore, it may be advantageous to have a chip that performs a diverse set of complex mathematical computations using a small hardware footprint and that has a reduced power-consumption characteristic.

### SUMMARY

An example embodiment provides a method to approximately calculate a mathematical function using a digital processing device that may include: performing at the digital processing device an acceleration function on at least one operand for a mathematical function in which the acceleration function may include a predetermined sequence of addition operations approximating the mathematical function, and the mathematical function may include a base-2 logarithm, a power of 2, a multiplication, an inverse square root, an inverse, a division, a square root, and an arctangent; and returning by the digital processing device a result of performing the acceleration function. In one embodiment, the predetermined sequence of addition operations may include a first predetermined number of additions of integer-formatted operands and a second predetermined number of additions of floating-point-formatted operands in which the additions of integer-formatted operands and additions of floating-point-formatted operands can occur in any order.

An example embodiment provides a digital-computing device that may include a memory and a digital processing device. The memory may store values. The digital processing device may be coupled to the memory. The digital processing device may: perform an acceleration function for a mathematical function involving at least one value stored in the memory in which the acceleration function may include a predetermined sequence of addition operations approximating the mathematical function, and the mathematical function may include a base-2 logarithm, a power of 2, a multiplication, an inverse square root, an inverse, a division, a square root, and an arctangent; and may return a result of performing the acceleration function. In one embodiment, the predetermined sequence of addition operations may include a first predetermined number of additions of integer-formatted operands and a second predetermined number of additions of floating-point-formatted operands in which the additions of integer-formatted operands and additions of floating-point-formatted operands can occur in any order.

### BRIEF DESCRIPTION OF THE DRAWING

In the following section, the aspects of the subject matter disclosed herein will be described with reference to exemplary embodiments illustrated in the figure, in which:

FIG. 1 depicts an example sequence of computing a complex mathematical function using an approximation based on add and shift operations according to the subject matter disclosed herein;

FIG. 2 depicts an example of a typical histogram of gradient (HoG) detector using computationally complex mathematical functions showing where acceleration functions may be used to accelerate computation and reduce latency and power consumption according to the subject matter disclosed herein; and

FIG. 3 depicts an electronic device that includes a digital-based processing device that performs acceleration functions according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. The software may be embodied as a software package, code and/or instruction set or instructions, and the term “hardware,” as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-chip (SoC) and so forth.

The subject matter disclosed herein provides a system and a method that approximates complex mathematical functions using combinations of add and shift operations that use less power and/or chip area to implement, and provides an improved latency to produce a result. The subject matter disclosed herein may be used to replace an exact mathematical function that is computationally complex and expensive, such as a multiplication operation, with a function that is an approximation to the mathematical function. In one embodiment, the subject matter disclosed herein approximates computationally complex functions by using combinations of ADD and SHIFT operations exclusively while maintaining a high accuracy (i.e., having an error of under about 0.3%.) The approximating function that replaces a computationally complex mathematical function may be referred to herein as an acceleration function because the approximating function runs faster than the computationally complex mathematical function corresponding to the acceleration function.

Using an acceleration function to replace a computationally complex mathematical function may reduce computational workload for a digital-based processing device and/or a digital-based application. Computationally complex mathematical functions that may be replaced by an acceleration function may include a convolution, a dot-product, a matrix multiplication, a square root, a logarithm, a division, a trigonometric function (sine and/or cosine), and/or a Fourier transform. Such acceleration function may also provide, for example, a bit reduction from a 32-bit floating-point number to a 1-bit-to-16-bit integer (or lower-bit (low-bit), i.e., 12-bit, 10-bit, etc.); integer-base operations instead of floating-point-based operations; reduction of multiplication operations by using exclusive OR (XOR) operations, shift operations, lookup tables; and numerical approximations, such as a Taylor series or a Newton's method.

The subject matter disclosed herein is applicable to machine-learning and computer-vision algorithms for training and inference on edge devices, while also being applicable to accelerate arbitrary algorithms and applications. Hardware architecture may be simplified and accelerated by replacing circuitry for complex mathematical operations with circuitry for addition, subtraction and shifting operations.

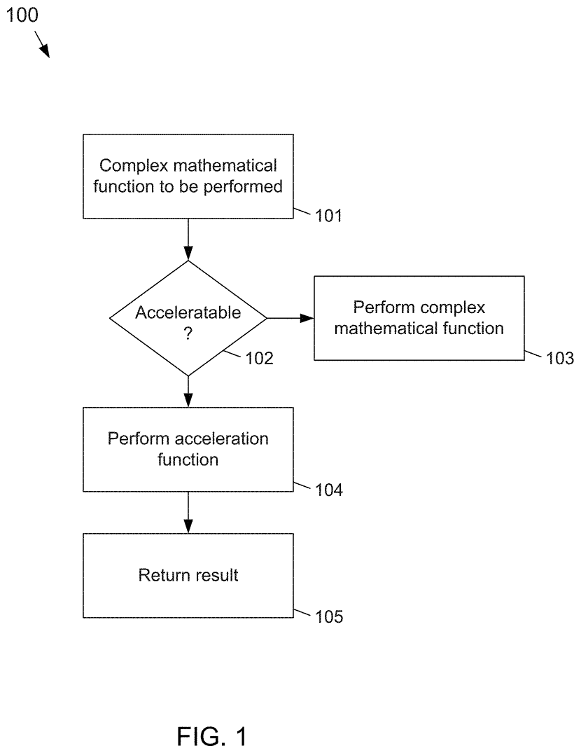

FIG. 1 depicts an example sequence 100 of computing a complex mathematical function using an approximation based on add and shift operations according to the subject matter disclosed herein. It should be understood that the underlying hardware performing the example sequence 100 may be configured to include hardware to perform an approximation based on add and shift operations. In one embodiment, the subject matter disclosed herein may be embodied as a module that may include any combination of software, firmware and/or hardware that has been configured to provide the functionality described herein in connection with acceleration functions.

At 101, a complex mathematical function is to be performed by a digital processing device, such as a controller 310 and/or an image processing device 350 (both in FIG. 5). For example, the complex mathematical function may include, but not limited to, a convolution, a dot-product, a matrix multiplication, a square root, a logarithm, a division, a trigonometric function (sine and/or cosine), and a Fourier transform. As disclosed herein, the complex mathematical function may be replaced by an acceleration function that is less computationally complex and that may be based on add and shift operations.

At 102, it is determined whether the complex mathematical function may be approximated by a corresponding acceleration function. If not, flow continues to 103, where the computationally complex mathematical function is executed. If, at 102, the mathematical function may be approximated by a corresponding acceleration function, flow continues to 104, where the acceleration function, which may be a predetermined sequence of add and shift operations corresponding to the computationally complex mathematical, is performed. The operand(s) for the complex mathematical function may be floating-point and/or integer numbers that may be represented using the IEEE 754 format.

Table 1 shows an example set of acceleration functions that may include a sequence of add and/or binary shift operations and that may be used to approximate complex mathematical functions. Other functions that are not shown in Table 1 may be approximated by a numerical approximation (such as a Taylor series), and then each term of the approximation may be replaced by ADD/SUB/SHIFT operations.

TABLE 1

| Function | Acceleration Function | Complexity | Domain | Error Bound |
|---|---|---|---|---|
| log2(x) | e + m + Σ₀ | 1 fadd, 1 iadd | [2⁻¹⁰, 2¹⁰] | 0.043 |
| pow2(x) | t ← x − Σ₀; e← └t┘; m← x − └t┘ | 1 fadd, 1 iadd | [−10, 10] | 3% |
| mul(x, y) | pow2(log2(x) + log2(y)) | 2 iadd | [0, 100] | 6% |
| isqrt(x) | Σ₁ − (x >> 1) | 1 iadd | [10⁻⁸, 10⁴] | 4% |
| inv(x) | isqrt(mul(x, x) | | — | — |
| | Σ₂ − x | 1 iadd | | |
| div(y, x) | mul(y, inv(x)) | | [1, 255] | 7% |
| | pow2(log2(x) − log2(y)) | 2 iadd | | |
| sqrt(x) | isqrt(isqrt(mul(x, x))) | | [−255, 255] | 6% |
| | Σ₃ + (x >> 1) | 1 iadd | | |
| atan(y, x) | div(y, x) | 2 iadd | [−255, 255] | 5° |

In Table 1, the left-most column lists some example complex mathematical functions that may be approximated by acceleration function that use a sequence of add and shift operations. The next column to the right shows the less-complex acceleration function that may be performed used to replace the complex mathematical function in the same row. The middle column shows the complexity of the acceleration function in which “fadd” represents a floating-point addition operation and “iadd” represents an integer addition operation. The column titled “Domain” shows the domain, or range, of an input to the acceleration function, and the right-most column shows the error bound for the acceleration function.

In the first row of Table 1, the complex mathematical function is a base-2 logarithm of x (i.e., log 2(x)). The operand x of the complex mathematical function should be in a floating-point format having a mantissa value and an exponent value. The acceleration function generates the base-2 logarithm of x by adding the mantissa (m) and the exponent (e) values as an integer addition operation, and then adding a value Σ₁ to the sum of the mantissa and the exponent as a floating-point addition operation. The value Σ₀ is a constant offset that increases the accuracy of the approximation for log 2(x). The values of Σ₀ and of the other constants indicated as Σ₁-Σ₃ in Table 1, which may be referred to as a “magic numbers,” may vary from function to function and may vary depending on the number of bits of the mantissa.

In the second row of Table 1, the complex mathematical function is 2 to the power of x (i.e., pow2(x)). A temporary value t in an integer format may be generated as the operand x minus (or a negative addition) the value a. A floor function may be performed on the temporary value of t to generate an exponent of the result of 2 to the power of x. The mantissa may be generated as the operand x minus the floor function of the temporary value t.

In the third row of Table 1, the complex mathematical function is a multiplication of a first operand x and a second operand y (i.e., mul(x,y)). The acceleration function for mul(x,y) is pow2(log 2(x)+log 2(y)), which has a theoretical error bound [E−, E+] of [2/(1.5−σ/2)2−1, +σ], or about ±6%. The acceleration function for log 2(x) appears in the first row of Table 1, and the acceleration function for pow2(x) appears in the second row of Table 1. Quantization error may become large for small integer values. The following example pseudo code includes a correction term for a more accurate result:
IF mx+my<1
   MUL_C(x,y)←MUL(X,Y)+MUL(POW2(eₓ+e_{y}),MUL(mₓ,m_{y}))
ELSE
   MUL_C(x,y)←MUL(X,Y)+MUL(POW2(eₓ+e_{y}), MUL(1−mₓ, 1−m_{y}))
ENDIF

The above example pseudo code results in a 20× error reduction of ±0.3%. The error reduction is shown in Table 2.

TABLE 2

| | | INT | | | | |
|---|---|---|---|---|---|---|
| | | x*y | MUL(x, y) | MUL_C(x, y) | | |
| | | 8 bit | 16 bit | 16 bit | 12 bit | 10 bit |
| Absolute | α | 0.1835 | 0.8581 | 0.0475 | 0.1300 | 0.5110 |
| Error | | | | | | |
| Relative | α | 1.6% | 2.7% | 0.15% | 0.33% | 1.2% |
| Error | Error | ±22% | ±2.4% | ±0.42% | ±0.84% | ±2.9% |
| (%) | Bound | | | | | |

The results in Table 2 were obtained from a Monte Carlo simulation from 10,000 (x,y) value pairs in the range (0,10]. The absolute error may be defined as z_est−z_act. The relative error may be defined as (z_est−z_act)/z_act*100%.

Returning to Table 1, in the fourth row of Table 1, the complex mathematical function is the inverse square root of the operand x (i.e., isqrt(x)). The acceleration function is a constant (Σ₁) minus the value resulting from a binary shift of the operand x in an integer format to the right. The constant Σ₁ may be derived from the constant Σ₀.

In the fifth row of Table 1, the complex mathematical function is the inverse of the operand x (i.e., inv(x)). One acceleration function for the inverse of the operand x is the inverse square root of the multiplication of x times x, which are respective shown in rows 4 and 3 of Table 1. Another acceleration function is a constant (Σ₂) minus the operand x in an integer format.

In the sixth row of Table 1, the complex mathematical function is the quotient of dividend y by a divisor x (i.e., div(y,x)). One acceleration function for div(y,x) is the multiplication of y by the inverse of x, which is respectively shown in rows 3 and 4 of Table 1. Another acceleration function for div(x,y) is pow2(log 2(x)−log 2(y)). The acceleration function for log 2(x) is shown in the first row of Table 1, and the acceleration function for pow2(x) is shown in the second row of Table 1.

In the seventh row of Table 1, the complex mathematical function is the square root of an operand x (i.e., sqrt(x)). One acceleration function for sqrt(x) is isqrt(isqrt(mul(x,x))) in which the acceleration function for mul(x,x) is shown in row 3 of Table 1, and the acceleration function for isqrt(x) is shown in row 4 of Table 1. Another acceleration function for sqrt(x) is a constant (Σ₃) plus the operand x in an integer format. Example pseudo code for an acceleration function formed by shifting and addition operations for sqrt(x) is shown below.

```
/* Assumes that float is in the IEEE 754 single-precision
floating-point format
  * and that int is 32 bits. */
float sqrt_approx(float z)
{
  int val_int = *(int*)&z; /* Same bits, but as an int */
  /*
    * To justify the following code, prove that
    *
    * ((((val_int / 2\hat{ }m) − b) / 2) + b) * 2\hat{ }m = ((val_int − 2\hat{ }m) / 2) +
    ((b + 1) / 2) * 2\hat{ }m)
    *
    * where
    *
    * b = exponent bias
    * m = number of mantissa bits
    *
    * .
    */
  val_int −= 1 << 23; /* Subtract 2\hat{ }m. */
  val_int >>= 1; /* Divide by 2. */
  val_int += 1 << 29; /* Add ((b + 1) / 2) * 2\hat{ }m. */
  return *(float*)&val_int; /* Interpret again as float */
```

}

In the eighth row of Table 1, the complex mathematical function is the arctangent of y and x (i.e., atan(y,x)). The acceleration function is div(y,x) and is shown in the sixth row of Table 1.

Referring back to FIG. 1, at 104, the selected acceleration function is performed. Depending upon the particular acceleration function selected and the original mathematical function, the operands of the mathematical function may be converted from a floating-point format to an integer format before the acceleration function is performed. At 105, the result of the acceleration function is returned.

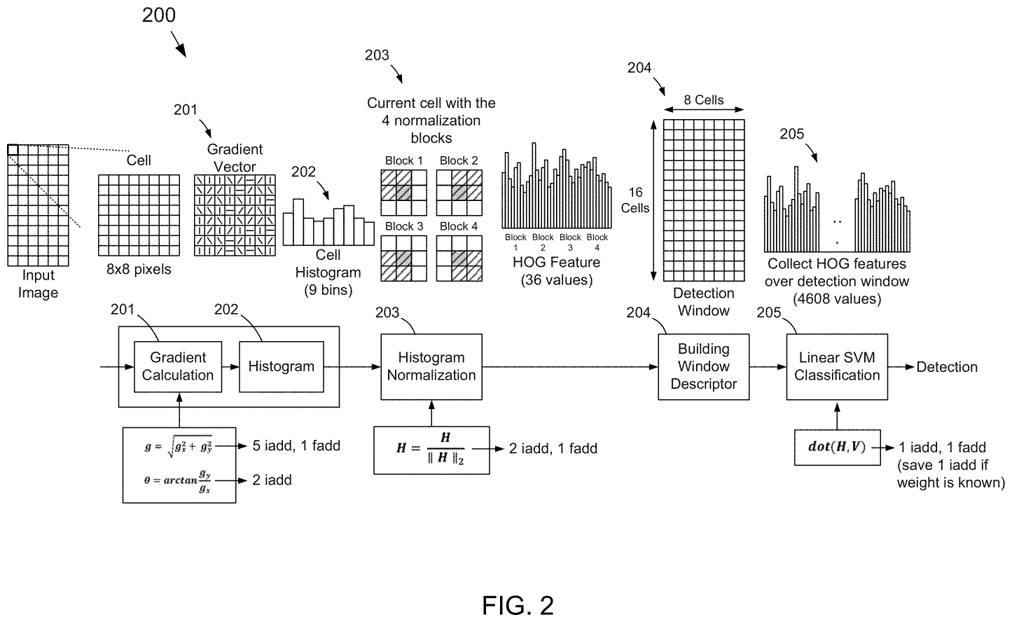

FIG. 2 depicts an example of a typical histogram of gradient (HoG) detector 200 using computationally complex mathematical functions showing where acceleration functions may be used to accelerate computation and reduce latency and power consumption according to the subject matter disclosed herein. The top portion of FIG. 2 depicts various stages of data of the HoG detector 200. An input image is processed to form cells of 8×8 pixels. Gradient vectors are calculated for each pixel, and a histogram of the cell gradients are generated at 202. The typical complex mathematical functions used at 202 may include:

g=\sqrt{gₓ²+h_{y}²}

and

$$θ = arctan \frac{{ℊ}_{y}}{{ℊ}_{x}}$$

in which gₓ is the gradient in the x direction, and g_{y} is the gradient in the y direction.

The complex calculation for g may be replaced by 1-bit acceleration functions resulting in 5 iadd operations and 1 fadd operation. The complex calculation for 0 may be replaced by acceleration functions resulting in 2 iadd operations.

At 203 in FIG. 2, histogram normalization occurs. The typical complex mathematical function used to calculate histogram normalization may be

$$H = \frac{H}{{‖ H ‖}_{2}}$$

in which H is a histogram and ∥H∥₂ is the magnitude of H in which ∥ ∥₂ is an operation that computes the magnitude of a vector.

The typical complex calculation for histogram normalization may be replaced by low-bit acceleration functions resulting in 2 iadd operations and 1 fadd operation.

At 204, a window descriptor is built, and at 205 linear support vector machine (SVM) classification may be calculated. A typical linear SVM classification may be
dot(H,V)
   in which H is the normalized histogram from above, and V is a vector of the parameter, or weights, of the SVM classifier.

The typical complex linear SVM classification may be replaced by low-bit acceleration functions resulting in 1 iadd operation and 1 fadd operation. If a weight value is known for the linear SVM classification, the 1 iadd operation may be saved. In summary, the total acceleration function operations for pixel 8.3 iadd/pixel, 1.6 fadd/pixel, and a 9 kB memory access (which may be small enough for a Level 1 (L1) cache).

Table 3 sets forth the cost per pixel for a typical HoG detector using complex computations and the cost per pixel for an HoG detector using acceleration functions according to the subject matter disclosed herein.

TABLE 3

Cost/pixel for Typical HoG Detector

| | fmul | fadd | I/O | Total |
|---|---|---|---|---|
| Operations | 11.4* | 1.7 | 9 bit | — |
| Energy | 12.5 | 0.7 | 5 | 18.2 |
| (pJ) | | | | |
| Latency | 57 | 5 | 1 | 63 |

Cost/pixel for Accelerated HoG Detector

| | Iadd | fadd | I/O | Total |
|---|---|---|---|---|
| Operations | 7.6 | 1.7 | 9 bit | — |
| Energy | 0.4 | 0.7 | 5 | 6.1 |
| (pJ) | | | | |
| Latency | 1 | 5 | 1 | 7 |

*Assuming each complex function (div, sqrt, atan) may be computed by four (4) floating-point multiplication operations in a general hardware implementation.

As can be seen in Table 3, the total power consumption may be reduced to be one-third of the original power consumption and the total latency may be reduced to be one-ninth of the original latency.

Table 4 sets forth the training and testing accuracy of a typical HoG detector and an HoG detector using low-bit acceleration functions according to the subject matter disclosed herein.

TABLE 4

| | | | | |
|---|---|---|---|---|
| | # | # true | # fal | |
| # pos | neg | pos | neg | accuracy |

Training Accuracy (1111 samples)

| | | | | | |
|---|---|---|---|---|---|
| Typical | 282 | 829 | 278 | 3 | 99.37% |
| HoG | | | | | |
| Acclr | 288 | 823 | 278 | 3 | 99.83% |
| HoG | | | | | |

| | | | |
|---|---|---|---|
| Ground | 281 | 830 | — |
| Truth | | | |

Test Accuracy (1111 samples)

| | | | | | |
|---|---|---|---|---|---|
| Typical | 281 | 830 | 277 | 3 | 99.28% |
| HoG | | | | | |
| Acclr | 285 | 826 | 276 | 5 | 98.74% |
| HoG | | | | | |

| | | | |
|---|---|---|---|
| Ground | 281 | 830 | — |
| Truth | | | |

As can be seen from Table 4, using acceleration functions results in only a 0.5% drop in performance of person detection over 2000 samples.

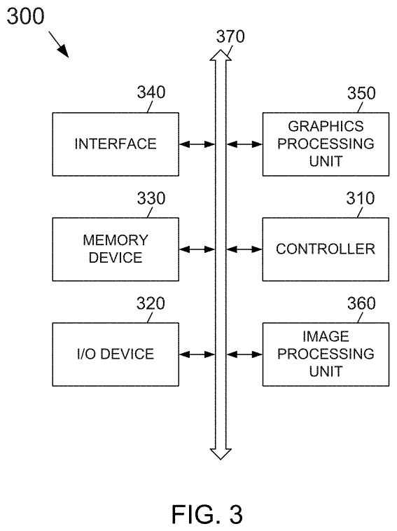

FIG. 3 depicts an electronic device 300 that includes a digital-based processing device that performs acceleration functions according to the subject matter disclosed herein. Electronic device 300 may be used in, but not limited to, a computing device, a personal digital assistant (PDA), a laptop computer, a mobile computer, a web tablet, a wireless phone, a cell phone, a smart phone, a digital music player, or a wireline or wireless electronic device. The electronic device 300 may include a controller 310, an input/output device 320 such as, but not limited to, a keypad, a keyboard, a display, a touch-screen display, a camera, and/or an image sensor, a memory 330, an interface 340, a GPU 350, and an imaging processing unit 360 that are coupled to each other through a bus 370. In one embodiment, the imaging processing unit 360 may include a digital-based processing device that performs acceleration functions according to the subject matter disclosed herein. The controller 310 may include, for example, at least one microprocessor, at least one digital signal processor, at least one microcontroller, or the like. The memory 330 may be configured to store a command code to be used by the controller 310 or a user data.

Electronic device 300 and the various system components of electronic device 300 may include a digital-based processing device, such as the controller 310, that performs acceleration functions on information stored in the memory device 330 according to the subject matter disclosed herein. The interface 340 may be configured to include a wireless interface that is configured to transmit data to or receive data from a wireless communication network using a RF signal. The wireless interface 340 may include, for example, an antenna, a wireless transceiver and so on. The electronic system 300 also may be used in a communication interface protocol of a communication system, such as, but not limited to, Code Division Multiple Access (CDMA), Global System for Mobile Communications (GSM), North American Digital Communications (NADC), Extended Time Division Multiple Access (E-TDMA), Wideband CDMA (WCDMA), CDMA2000, Wi-Fi, Municipal Wi-Fi (Muni Wi-Fi), Bluetooth, Digital Enhanced Cordless Telecommunications (DECT), Wireless Universal Serial Bus (Wireless USB), Fast low-latency access with seamless handoff Orthogonal Frequency Division Multiplexing (Flash-OFDM), IEEE 802.20, General Packet Radio Service (GPRS), iBurst, Wireless Broadband (WiBro), WiMAX, WiMAX-Advanced, Universal Mobile Telecommunication Service-Time Division Duplex (UMTS-TDD), High Speed Packet Access (HSPA), Evolution Data Optimized (EVDO), Long Term Evolution-Advanced (LTE-Advanced), Multichannel Multipoint Distribution Service (MMDS), and so forth.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of, data-processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method to approximately calculate a mathematical function using a digital processing device, the method comprising:
performing at the digital processing device an acceleration function on at least one operand for a mathematical function, the acceleration function comprising a predetermined sequence of addition operations approximating the mathematical function, and the mathematical function comprising a base-2 logarithm, a power of 2, a multiplication, an inverse square root, an inverse, a division, a square root, and an arctangent; and
returning by the digital processing device a result of performing the acceleration function.

2. The method of claim 1, wherein the predetermined sequence of addition operations comprises a first predetermined number of additions of integer-formatted operands and a second predetermined number of additions of floating-point-formatted operands in which the additions of integer-formatted operands and additions of floating-point-formatted operands can occur in any order.

3. The method of claim 1, wherein the mathematical function comprises a base-2 logarithm of a first operand in a floating-point format, and
wherein performing the acceleration function further comprises:
selecting a mantissa part of the first operand to be a second operand in an integer format;
selecting an exponent part of the first operand to be a third operand in the integer format;
adding the second operand to the third operand to form a fourth operand; and
adding a predetermined constant in the integer format to the fourth operand, the fourth operand being an approximation of the base-2 logarithm of the first operand.

4. The method of claim 1, wherein the mathematical function comprises a power of 2 of a first operand in a floating-point format, and
wherein performing the acceleration function further comprises:
selecting a mantissa part of the first operand to be a second operand in an integer format;
selecting an exponent part of the first operand to be a third operand in the integer format;
adding the second operand to a negative value of a predetermined constant to form a fourth operand,
determining a fifth operand to be a floor value of the fourth operand; and
determining a sixth operand by adding the fourth operand to a negative of the floor value of the fourth operand, the fifth operand being an exponent of the power of 2 of the first operand and the sixth operand being a mantissa of the power of 2 of the first operand.

5. The method of claim 1, wherein the mathematical function comprises a multiplication of a first operand in a floating-point format and a second operand in the floating-point format, and
wherein performing the acceleration function further comprises:
selecting a mantissa part of the first operand to be a third operand in an integer format;
selecting an exponent part of the first operand to be a fourth operand in the integer format;
adding the third operand to the fourth operand to form a fifth operand,
adding a predetermined constant in the integer format to the fifth operand, the fifth operand being an approximation of a binary logarithm of the first operand;
selecting a mantissa part of the second operand to be a sixth operand in an integer format;
selecting an exponent part of the second operand to be a seventh operand in the integer format;
adding the sixth operand to the seventh operand to form an eighth operand, adding the predetermined constant in the integer format to the eighth operand, the eight operand being an approximation of a binary logarithm of the second operand;
adding the fifth operand and the eighth operand to form a ninth operand in the floating-point format;
selecting a mantissa part of the ninth operand to be a tenth operand in an integer format;
selecting an exponent part of the ninth operand to be an eleventh operand in the integer format;
adding the eleventh operand to a negative value of the predetermined constant to form a twelfth operand,
determining a thirteenth operand to be a floor value of the twelfth operand; and
determining a fourteenth operand by adding the twelfth operand to a negative of the floor value of the twelfth operand, the thirteenth operand being an exponent of an approximation of a product of the first operand and the second operand and the fourteenth operand being a mantissa of the approximation of the product of the first operand and the second operand.

6. The method of claim 1, wherein the mathematical function comprises an inverse square root of a first operand in an integer format, and
wherein performing the acceleration function further comprises:
shifting the first operand one bit in a direction toward a least-significant bit of the first operand to form a second operand; and
adding a first predetermined constant to a negative of the second operand to form an approximation of the inverse square root of the first operand.

7. The method of claim 1, wherein the mathematical function comprises an inverse of a first operand in an integer format, and
wherein approximately calculating the mathematical function by the digital processing device further comprises adding a predetermined constant to a negative of the first operand to form an approximation of the inverse of the first operand.

8. The method of claim 1, wherein the mathematical function comprises a division of a first operand in a floating-point format by a second operand in the floating-point format, and
wherein performing the acceleration function further comprises:
selecting a mantissa part of the first operand to be a third operand in an integer format;
selecting an exponent part of the first operand to be a fourth operand in the integer format;
adding the third operand to the fourth operand to form a fifth operand,
adding a predetermined constant in the integer format to the fifth operand, the fifth operand being an approximation of a binary logarithm of the first operand;
selecting a mantissa part of the second operand to be a sixth operand in an integer format;
selecting an exponent part of the second operand to be a seventh operand in the integer format;
adding the sixth operand to the seventh operand to form an eighth operand,
adding the predetermined constant in the integer format to the eighth operand, the eight operand being an approximation of a binary logarithm of the second operand;
adding the fifth operand to a negative of the eighth operand to form a ninth operand in the floating-point format;
selecting a mantissa part of the ninth operand to be a tenth operand in an integer format;
selecting an exponent part of the ninth operand to be an eleventh operand in the integer format;
adding the eleventh operand to a negative value of the predetermined constant to form a twelfth operand,
determining a thirteenth operand to be a floor value of the twelfth operand; and
determining a fourteenth operand by adding the twelfth operand to a negative of the floor value of the twelfth operand, the thirteenth operand being an exponent of an approximation of a quotient of the first operand and the second operand and the fourteenth operand being a mantissa of the approximation of the quotient of the first operand and the second operand.

9. The method of claim 1, wherein the mathematical function comprises a square root of a first operand in an integer format, and
wherein performing the acceleration function further comprises:
shifting the first operand one bit in a direction toward a least-significant bit of the first operand to form a second operand; and
adding a first predetermined constant to a negative of the second operand to form an approximation of the square root of the first operand.

10. A digital-computing device, comprising:
a memory that stores values; and
a digital processing device coupled to the memory, the digital processing device:
performing an acceleration function for a mathematical function involving at least one value stored in the memory, the acceleration function comprising a predetermined sequence of addition operations approximating the mathematical function, and the mathematical function comprising a base-2 logarithm, a power of 2, a multiplication, an inverse square root, an inverse, a division, a square root, and an arctangent; and
returning a result of performing the acceleration function.

11. The digital-computing device of claim 10, wherein the predetermined sequence of addition operations comprises a first predetermined number of additions of integer-formatted operands and a second predetermined number of additions of floating-point-formatted operands in which the additions of integer-formatted operands and additions of floating-point-formatted operands can occur in any order.

12. The digital-computing device of claim 10, wherein the mathematical function comprises a base-2 logarithm of a first operand in a floating-point format, and
wherein the digital processing device performs the acceleration function by:
selecting a mantissa part of the first operand to be a second operand in an integer format;
selecting an exponent part of the first operand into a third operand in the integer format;
adding the second operand to the third operand to form a fourth operand; and
adding a predetermined constant in the integer format to the fourth operand, the fourth operand being an approximation of the base-2 logarithm of the first operand.

13. The digital-computing device of claim 10, wherein the mathematical function comprises a power of 2 of a first operand in a floating-point format, and
wherein the digital processing device performs the acceleration function by:
selecting a mantissa part of the first operand to be a second operand in an integer format;
selecting an exponent part of the first operand to be a third operand in the integer format;
adding the second operand to a negative value of a predetermined constant to form a fourth operand,
determining a fifth operand to be a floor value of the fourth operand; and
determining a sixth operand by adding the fourth operand to a negative of the floor value of the fourth operand, the fifth operand being an exponent of the power of 2 of the first operand and the sixth operand being a mantissa of the power of 2 of the first operand.

14. The digital-computing device of claim 10, wherein the mathematical function comprises a multiplication of a first operand in a floating-point format and a second operand in the floating-point format, and
wherein the digital processing device performs the acceleration function by:
selecting a mantissa part of the first operand to be a third operand in an integer format;
selecting an exponent part of the first operand to be a fourth operand in the integer format;
adding the third operand to the fourth operand to form a fifth operand,
adding a predetermined constant in the integer format to the fifth operand, the fifth operand being an approximation of a binary logarithm of the first operand;
selecting a mantissa part of the second operand to be a sixth operand in an integer format;
selecting an exponent part of the second operand to be a seventh operand in the integer format;
adding the sixth operand to the seventh operand to form an eighth operand,
adding the predetermined constant in the integer format to the eighth operand, the eight operand being an approximation of a binary logarithm of the second operand;
adding the fifth operand and the eighth operand to form a ninth operand in the floating-point format;
selecting a mantissa part of the ninth operand to be a tenth operand in an integer format;
selecting an exponent part of the ninth operand to be an eleventh operand in the integer format;
adding the eleventh operand to a negative value of the predetermined constant to form a twelfth operand,
determining a thirteenth operand to be a floor value of the twelfth operand; and
determining a fourteenth operand by adding the twelfth operand to a negative of the floor value of the twelfth operand, the thirteenth operand being an exponent of an approximation of a product of the first operand and the second operand and the fourteenth operand being a mantissa of the approximation of the product of the first operand and the second operand.

15. The digital-computing device of claim 10, wherein the mathematical function comprises an inverse square root of a first operand in an integer format, and
wherein the digital processing device performs the acceleration function by:
shifting the first operand one bit in a direction toward a least-significant bit of the first operand to form a second operand; and
adding a first predetermined constant to a negative of the second operand to form an approximation of the inverse square root of the first operand.

16. The digital-computing device of claim 10, wherein the mathematical function comprises an inverse of a first operand in an integer format, and
wherein the digital processing device performs the acceleration function by adding a predetermined constant to a negative of the first operand to form an approximation of the inverse of the first operand.

17. The digital-computing device of claim 10, wherein the mathematical function comprises a division of a first operand in a floating-point format by a second operand in the floating-point format, and
wherein the digital processing device performs the acceleration function by:
selecting a mantissa part of the first operand to be a third operand in an integer format;
selecting an exponent part of the first operand to be a fourth operand in the integer format;
adding the third operand to the fourth operand to form a fifth operand,
adding a predetermined constant in the integer format to the fifth operand, the fifth operand being an approximation of a binary logarithm of the first operand;
selecting a mantissa part of the second operand to be a sixth operand in an integer format;
selecting an exponent part of the second operand to be a seventh operand in the integer format;
adding the sixth operand to the seventh operand to form an eighth operand,
adding the predetermined constant in the integer format to the eighth operand, the eight operand being an approximation of a binary logarithm of the second operand;
adding the fifth operand to a negative of the eighth operand to form a ninth operand in the floating-point format;
selecting a mantissa part of the ninth operand to be a tenth operand in an integer format;
selecting an exponent part of the ninth operand to be an eleventh operand in the integer format;
adding the eleventh operand to a negative value of the predetermined constant to form a twelfth operand,
determining a thirteenth operand to be a floor value of the twelfth operand; and
determining a fourteenth operand by adding the twelfth operand to a negative of the floor value of the twelfth operand, the thirteenth operand being an exponent of an approximation of a quotient of the first operand and the second operand and the fourteenth operand being a mantissa of the approximation of the quotient of the first operand and the second operand.

18. The digital-computing device of claim 10, wherein the mathematical function comprises a square root of a first operand in an integer format, and
wherein the digital processing device performs the acceleration function by:
shifting the first operand one bit in a direction toward a least-significant bit of the first operand to form a second operand; and
adding a first predetermined constant to a negative of the second operand to form an approximation of the square root of the first operand.
